(19) United States
(12) Patent Application Publication
(10) Pub. No.: US 2005/0143058 A1
(43) Pub. Date: Jun. 30, 2005

(54) Method for detecting receipt of input in wireless communication terminal by using interrupt handler

(76) Inventors: Kyung-Ah Chang, Kyoungki-do (KR); Man Won, Kyoungki-do (KR); Hak-Jae Kim, Kyoungki-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/971,977

(22) Filed: Oct. 22, 2004

(30) Foreign Application Priority Data
Dec. 29, 2003 (KR) 2003-98907

(51) Int. Cl. H04M 3/00

(52) U.S. Cl. 455/418; 455/575.1

(57) ABSTRACT

A wireless communication terminal controlling an input detecting operation by using an interrupt handler is disclosed. The wireless communication terminal includes: a general purpose input output (GPIO) port for receiving an input, changing a state of the GPIO port according to the input and transmitting a signal when the input is received; a first timer for providing a first predetermined interval; a second timer for providing a second predetermined interval; a controlling unit for activating the interrupt handler to receive the signal from the GPIO port and generate an interrupt by receiving the signal for activating the first timer and the second timer, un-activating the interrupt handler when the interrupt handler generates the interrupt, performing the input detecting operation based on the first predetermined interval, re-activating the interrupt handler based on the second predetermined interval for stopping to perform the input detecting operation.

### FIELD OF THE INVENTION

The present invention relates to a wireless communication terminal detecting a receipt of input by using an interrupt handler; and, more particularly, to a wireless communication terminal controlling an input detecting operation by setting an interrupt handler to generate an interrupt for driving two timers and a method thereof.

### DESCRIPTION OF RELATED ARTS

A wireless communication terminal is a potable mobile terminal transceiving data through a wireless link. The wireless communication terminal may include a personal communication service (PCS) phone, a cellular phone, a personal digital assistance (PDA), a smart phone and a mobile terminal for international mobile telecommunication (IMT) 2000 and a wireless local area network (LAN) terminal.

Generally, the wireless communication terminal detects an input from a user by using a timer. That is, the timer is set to expire in a predetermined time such as 20-30 ms and an input detecting operation is performed for detecting the input from the user by polling states of a plurality of GPIO ports whenever the timer expires. The input detecting operation is a set of tasks for detecting the input from the user by pooling state of a plurality of GPIO ports, determining a type of the input, if there is the input from the user and performing appropriate service routines according to the type of the input.

As mentioned above, the input detecting operation is performed for determining whether any inputs from the user are received whenever the timer expires.

In a fact, mostly, there is no input received from the user when the timer expires. And, a time for receiving inputs from the user is very short comparing to a total operation time of the wireless communication terminal. Accordingly, the input detecting operations and operations of driving the timer mostly become un-meaningful operations.

Therefore, the wireless communication terminal wastes its resources for repeatedly performing un-meaningful operations.

Furthermore, the above mentioned un-meaningful operations may degrade a performance of the wireless communication terminal since the un-meaningful operations may become overhead of a CPU in the wireless communication terminal. Also, the un-meaningful operations delay other operations of the wireless communication terminal.

Recently, a color monitor is implemented into the wireless communication terminal and various additional equipments such as a digital camera or a global positioning system (GPS) are additionally implemented into the wireless communication terminal. The additional equipments of the wireless communication terminal cause to increase an amount of data to be processed in the wireless communication terminal. Therefore, unnecessary operations must be eliminated for increase a performance of the wireless communication terminal.

### SUMMARY OF THE INVENTION

It is, therefore, one object of the present invention to provide a wireless communication terminal and a method for controlling an input detecting operation by using an interrupt handler and two timers.

It is another object of the present invention to provide a wireless communication terminal and a method for detecting a receipt of an input from a user by using an interrupt handler that receives a signal from a general purpose input/output port (GPIO) port and generates an interrupt for driving two timers.

It is still another object of the present invention to provide a wireless communication terminal and a method for detecting a receipt of an input from a user by using an interrupt handler and performing an input detection operation when the interrupt handler detects the receipt of input.

It is further still another object of the present invention to provide a wireless communication terminal and a method for controlling an input detection operation to be performed by driving two timers.

In accordance with one aspect of the present invention, there is a provided wireless communication terminal including a general purpose input output (GPIO) port for receiving an input from a user, changing a state of the GPIO port according to the input and transmitting a signal when the input is received from the user; a first timer for providing a first predetermined interval of performing the input detecting operation; a second timer for providing a second predetermined interval of activating the interrupt handler; a controlling unit for activating the interrupt handler to receive the signal from the GPIO port and generate an interrupt by receiving the signal for activating the first timer and the second timer, un-activating the interrupt handler when the interrupt handler generates the interrupt, performing the input detecting operation based on the first predetermined interval, re-activating the interrupt handler based on the second predetermined interval for stopping to perform the input detecting operation.

In accordance with another aspect of the present invention, there is also a provided a method for controlling an input detecting operation by using an interrupt handler in wireless communication terminal, including the steps of: a) activating an interrupt handler to generate an interrupt by receiving a signal from a general purpose input output (GPIO) port when an input is received at the GPIO port; b) deactivating the interrupt handler when the interrupt handler generates the interrupt by receiving the signal from the GPIO port and activating a first timer and a second timer by receiving the interrupt from the interrupt handler; c) performing an input detecting operation when the first timer expires; and d) deactivating the input detecting operation when the second timer expires and re-activating the interrupt handler.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a diagram illustrating a wireless communication terminal controlling an input detecting operation by using an interrupt handler in accordance with a preferred embodiment of the present invention; and

FIG. 2 is a flowchart explaining a method for controlling an input detecting operation by using an interrupt handler in accordance with a preferred embodiment of the present invention.

### DETAILED DESCRIPTION OF THE INVENTION

Hereinafter, a wireless communication terminal controlling an input detecting operation by using an interrupt handler in accordance with a preferred embodiment of the present invention will be described in detail with reference to the accompanying drawings.

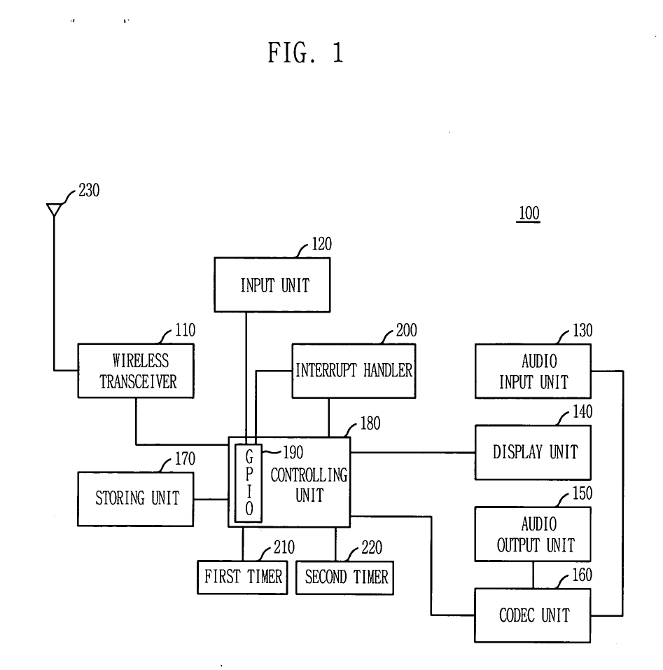

FIG. 1 is a diagram illustrating a wireless communication terminal controlling an input detecting operation by using an interrupt handler in accordance with a preferred embodiment of the present invention.

As shown, the wireless communication terminal 100 includes a wireless transceiver 110 for transceiving data through an antenna 230; an input unit 120 for receiving an input from a user; an audio input unit 130 for receiving a audio signal from the user; a displaying unit 140 for displaying information; an audio output unit 150 for outputting audio signal; a compression/decompression (CODEC) unit 160 for converting a radio frequency signal from the wireless transceiver 110 into the audio signal, passing the audio signal to the audio output unit 150, converting the audio signal from the audio input unit 130 into the digital signal for transmitting and passing the digital signal to the wireless transceiver 110; a storing unit 170 for storing programs for driving the wireless communication terminal 100 and file systems including image files, character files and icon files; a controlling unit 180; a general purpose input output (GPIO) port 190 for receiving the input from the input unit 120; an interrupt handler 200; a first timer 210 and a second timer 220.

The GPIO port 190 receives the input from the input unit 120. A state of the GPIO port 190 is varied according to receipt of input from the input unit 120. That is, when the GPIO port 190 receives the input from the input unit 120, the state may become high. Therefore, the controlling unit 180 can determine whether any input is received from the user by polling the state of the GPIO port 190. The wireless communication terminal 100 may have a plurality of the GPIO ports. Furthermore, the GPIO port 190 transmits a signal to the interrupt handler 200.

The interrupt handler 200 receives the signal from the GPIO port 190 when the GPIO port 190 receives any input from the user and generates an interrupt for activating the first timer 210 and the second timer 220. The interrupt handler 200 is activated for receiving the signal and generating the interrupt when the wireless communication terminal is initialized by being powered on or reset. Also, the interrupt handler 200 is re-activated when the second timer 220 expires. In contrary, the interrupt handler 200 is deactivated for not receiving the signal and not generating the interrupt after generating the interrupt by receiving the signal from the GPIO port.

The controlling unit 180 controls the interrupt handler 200 to be activated when the wireless communication terminal is initialized and deactivated after generating the interrupt, as mentioned above.

The controlling unit 180 also activates the first timer 210 and the second timer 220 when the controlling unit 180 receives the interrupt from the interrupt handler 200. Furthermore, the controlling unit 180 controls an input detecting operation according to the first and the second timers 210 and 220. The input detection operation is a set of tasks for detecting the input from the user by pooling state of a plurality of GPIO ports, determining a type of the input when there is the input from the user and performing appropriate service routines according to the type of the input. The input detecting operation is performed whenever the first timer 210 expires. Also, the input detecting operation is controlled to be not performed when the second timer 220 expires. That is, the controlling unit 180 re-activates the interrupt handler 200 when the second timer 220 expires. Accordingly, the input detecting operation is not performed since the first timer 210 is not activated and does not expire while the interrupt handler 200 is activated.

The first timer 210 provides a predetermined interval for performing the input detecting operation. The first timer 210 is activated when the interrupt handler 200 receives the signal from the GPIO port 190, wherein the signal representing of receipt of input from the user. The first timer 210 is deactivated when the second timer 220 expires. The first timer 210 is used for performing the input detection operation. That is, the input detecting operation is performed whenever the first timer 210 expires.

The second timer 220 provides a predetermined interval for re-activating the interrupt handler. The second timer 220 is activated when the interrupt handler 200 receives the signal from the GPIO, wherein the signal representing of receipt of input from the user. The second timer 220 is deactivated when the GPIO port 190 does not receive any input from the user during a predetermined time period after performing the input detecting operation. The second timer 220 is used for re-activating the interrupt handler 200.

As mentioned above, the wireless communication terminal 100 controls performing the input detecting operation and activating the first and the second timers 210, 220 by using the interrupt handler 210. Therefore, the first and the second timers 210 and 220 are not always running in the wireless communication terminal 100. Furthermore, the wireless communication terminal 100 does not perform the unnecessary input determining operation.

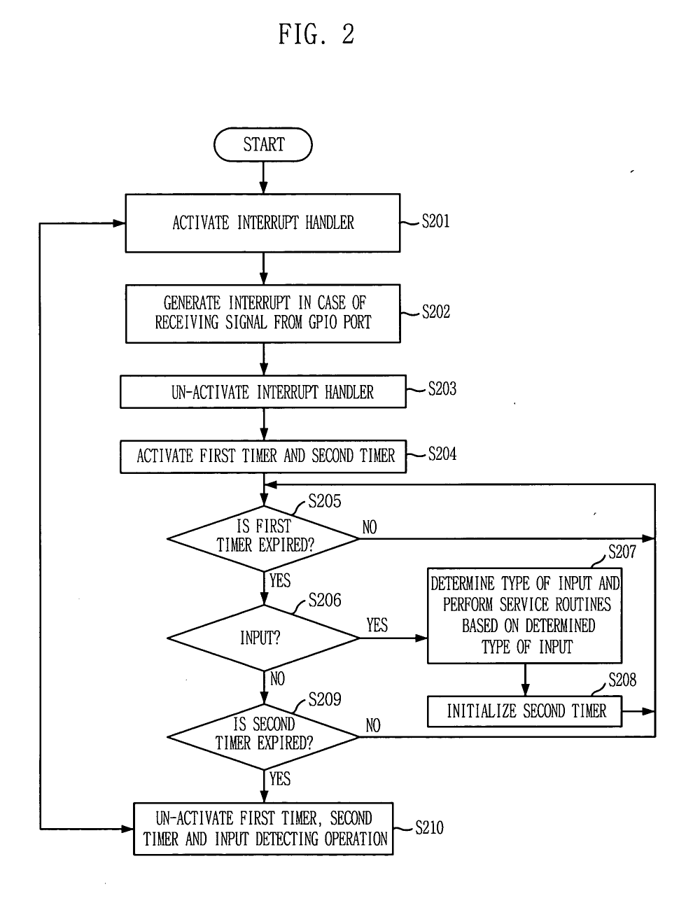

FIG. 2 is a flowchart explaining a method for controlling an input detecting operation by using an interrupt handler in accordance with a preferred embodiment of the present invention.

As shown in FIG. 2, a controlling unit of the wireless communication terminal activates an interrupt handler to generate an interrupt when the interrupt handler receives a signal representing receipt of an input from a general purpose input output (GPIO) port at step S201.

When the GPIO port receives the input from a user, the GPIO ports transmits the signal to the interrupt handler and the interrupt handler receives the signal from the GPIO port and generates an interrupt for activating a first timer and a second timer at step S202.

When the interrupt handler generates the interrupt, the controlling unit deactivates the interrupt handler to receive the signal and generates the interrupt at step S203.

After un-activating the interrupt handler, the controlling unit activates the first timer and the second timer at step S204.

At step S205, the controlling unit determines whether the first timer expires.

If the first timer expires, the controlling unit performs an input detection operation. That is, the controlling unit determines whether there is an input received from the user by polling a state of the GPIO port at step S206.

If there is the input, the controlling unit determines a type of the input and performs corresponding service routines based determined type of the input at step S207. After performing the service routines, the second timer is initialized at step S208.

After initializing the second timer, the step S205 is repeatedly performed.

If there is no input at step S206, the controlling unit determines whether the second timer expires at step S209.

If the second timer is not expired, the step S205 is repeatedly performed and if the second timer expires, the controlling unit deactivates the first timer and the second timer and also deactivates the input detection operation at step S210.

After un-activating, the controlling unit activates the interrupt handler to receive the signal from the GPIO and generate the interrupt for activating the first and the second timer by repeatedly performing the step S201.

As mentioned above, the wireless communication terminal detects receipt of an input from a user by using an interrupt handler. That is, the interrupt handler is activated to receive a signal from a GPIO port when the GPIO port receives the input from the user. Also, the wireless communication terminal of the present invention activates a first timer and a second timer by receiving an interrupt from the interrupt handler for performing an input detecting operation when there is input received from the user. That is, the wireless communication terminal does not perform the input detection operation and does not activate the timer when there is no input received from the user.

Therefore, the wireless communication terminal eliminates unnecessary operations and reduces overhead of the wireless communication terminal by using the interrupt handler.

The present application contains subject matter related to Korean patent application No. KR 2003-0098907, filed in the Korean patent office on Dec. 29, 2003, the entire contents of which being incorporated herein by reference.

While the present invention has been described with respect to certain preferred embodiments, it will be apparent to those skilled in the art that various changes and modifications may be made without departing from the spirit and scope of the invention as defined in the following claims.

1. A wireless communication terminal controlling an input detecting operation by using an interrupt handler, the wireless communication terminal comprising:
a general purpose input output (GPIO) port for receiving an input from a user, changing a state of the GPIO port according to the input and transmitting a signal when the input is received from the user;
a first timer for providing a first predetermined interval of performing the input detecting operation;
a second timer for providing a second predetermined interval of activating the interrupt handler;
a controlling unit for activating the interrupt handler to receive the signal from the GPIO port and generate an interrupt by receiving the signal for activating the first timer and the second timer, un-activating the interrupt handler when the interrupt handler generates the interrupt, performing the input detecting operation based on the first predetermined interval, re-activating the interrupt handler based on the second predetermined interval for stopping to perform the input detecting operation.

2. The wireless communication terminal of claim 1, wherein the controlling unit activates the interrupt handler and activates the first timer and the second timer when the wireless communication terminal is initialized, deactivates the interrupt handler by receiving the interrupt from the interrupt handler and re-activates the interrupt handler when the second timer expires.

3. The wireless communication terminal of claim 2, wherein the input detecting operation is a set of tasks for determining whether the input is received from a user by polling a state of the GPIO port, determining a type of the input when there is the input received from the user and performing corresponding service routines according to the type of the input.

4. The wireless communication terminal of claim 3, wherein the controlling unit deactivates the first timer and the second timer when the second timer expires and re-activates the interrupt handler.

5. A method for controlling an input detecting operation by using an interrupt handler in wireless communication terminal, comprising the steps of:
a) activating an interrupt handler to generate an interrupt by receiving a signal from a general purpose input output (GPIO) port when the GPIO port receives an input from a user;
b) generating the interrupt by receiving the signal from the GPIO port, deactivating the interrupt handler after generating the interrupt and activating a first timer and a second timer;
c) performing an input detecting operation when the first timer expires; and
d) deactivating the input detecting operation when the second timer expires and re-activating the interrupt handler.

6. The method of claim 5, wherein in the step b), the interrupt handler generates the interrupt by receiving the signal from the GPIO port when the input is inputted into the GPIO port and the interrupt handler is deactivated after generating the interrupt.

7. The method of claim 6, wherein in the step c), the input detecting operation is a set of tasks for determining whether the input is received from a user by polling a state of the GPIO port, determining a type of the input when there is the input received from the user and performing corresponding service routines according to the type of the input.

8. The method of claim 7, wherein in the step d), the first timer and the second timer are deactivated when the second timer expires and re-activates the interrupt handler.
